(19) United States
(12) Patent Application Publication
(10) Pub. No.: US 2014/0216601 A1
(43) Pub. Date: Aug. 7, 2014

(54) Method and Device for Refilling a Storage Tank

(71) Applicants: Helmut Henrich, Pulheim (DE); Franz Lurken, Kempen (DE)

(72) Inventors: Helmut Henrich, Pulheim (DE); Franz Lurken, Kempen (DE)

(73) Assignee: L'Air Liquide, Societe Anonyme pour l'Etude et l'Eploitation des Procedes Georges Claude, Paris (FR)

(21) Appl. No.: 14/342,138

(22) PCT Filed: Aug. 16, 2012
(86) PCT No.: PCT/EP2012/066027

§ 371 Date: Feb. 28, 2014

(30) Foreign Application Priority Data
Aug. 30, 2011 (EP) EP 11179317.0

(51) Int. Cl. F17C 7/02

(52) U.S. Cl. CPC F17C 7/02
USPC 141/4; 141/82

(57) ABSTRACT

The present invention relates to a method and a device for refilling a stationary storage tank with a subcooled cryogenically liquefied gas from a tanker. A subcooler, comprising a cooling bath and connected between the tanker and an inlet of the storage tank, is filled with the liquefied gas from the tanker up to a filling level and cooled to a bath temperature. The storage tank is subsequently refilled with the liquefied gas from the tanker by the liquefied gas being pumped through a heat exchanger in the cooling bath of the subcooler into the storage tank by using a delivery pump, during which it is cooled to the bath temperature of the cooling bath. After the end of the filling process, the subcooler is no longer supplied with liquefied gas and therefore heats up.

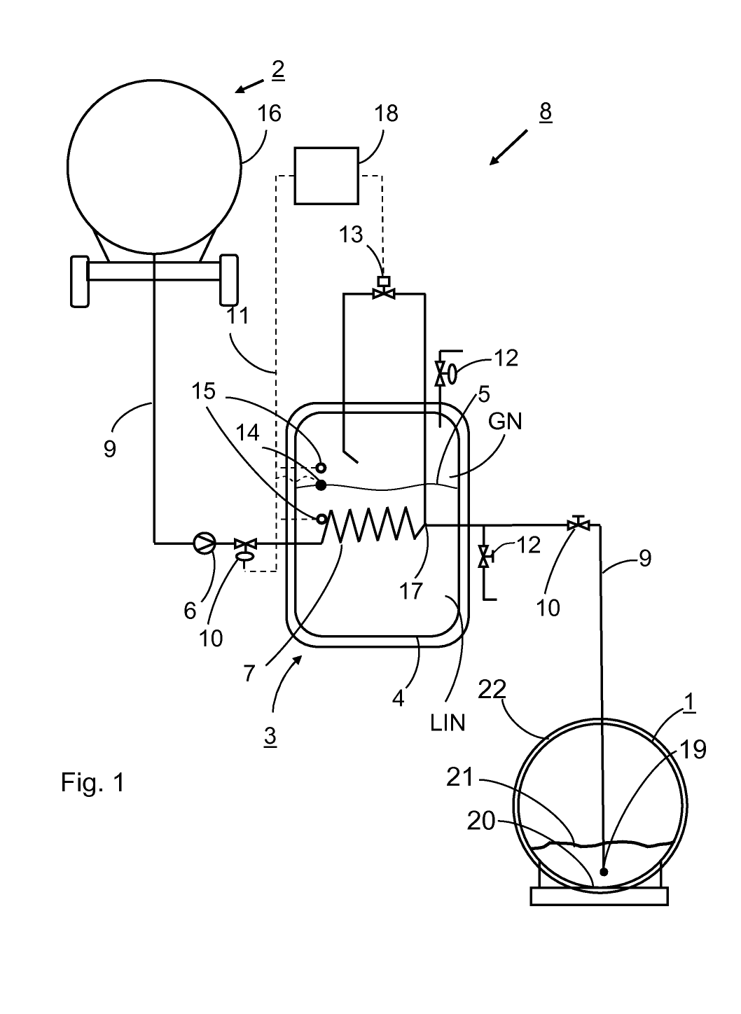

The present invention relates to a method and a device for refilling a stationary storage tank with a subcooled cryogenically liquefied gas from a tanker. The liquefied gas is, in particular, liquefied nitrogen (LIN).

At consumers of cryogenically liquefied gas, large-volume stationary storage tanks are generally installed from which the consumer can take the cryogenically liquefied gas. These storage tanks need to be refilled regularly. The refilling is carried out by means of tankers in which the cryogenically liquefied gas is usually transported in a subcooled state in a holding tank. A subcooled state is intended to mean that the cryogenically liquefied gas is at a temperature below the boiling point at the corresponding pressure.

Before the refilling, the storage tank is generally under pressure because of the cryogenically liquefied gas evaporating. This pressure is usually reduced by venting before the refilling process, such that still more cryogenically liquefied gas evaporates. The cryogenically liquefied gas stored in the tanker is subsequently transferred into the storage tank by the internal pressure in the tanker, without using pumps since this would lead to a further temperature rise of the cryogenically liquefied gas. This filling process therefore takes a relatively long time.

As an alternative, it is known to keep the stationary storage tank at a certain low pressure at all times and to carry out the refilling from a tanker by using a pump. In this case, however, the pump must permanently be kept in a cold state in order to avoid waiting times for cooling it down before the filling. Thus, the energy consumption with permanent cooling of the pump is high and the pump requires regular maintenance.

From the prior art, it is known to use subcoolers at the outlet of a stationary tank when subcooled liquefied gas is required at a consumer installation or a transport means. The subcoolers are in this case used to keep the temperature of the liquefied gas below the boiling point. A subcooler is described, for example, in EP 0 307 092 A1. The use of subcoolers for refilling a stationary storage tank from a tanker, however, has not previously been described.

It is therefore an object of the present invention to at least partially resolve the problems explained in relation to the prior art and, in particular, to provide a method and a device with which the refilling of a storage tank can be carried out more rapidly compared to the usual processes and/or more efficiently. Another object is to reduce variations of the pressure in a tank connected to consumers during a filling process.

These objects are achieved by a method, a device and a storage tank according to the features of the independent patent claims. Further advantageous configurations and features of the invention are indicated in the dependently formulated patent claims. It should be pointed out that the features mentioned individually in the dependent patent claims may be combined with one another in any desired technologically feasible way, and define further configurations of the invention. Furthermore, the features indicated in the patent claims are specified and explained in more detail in the description, with other preferred configurations of the invention being presented.

In particular, the objects are achieved by a method for refilling a stationary storage tank with a cryogenically liquefied gas from a tanker, in particular with a subcooled cryogenically liquefied gas, comprising the following steps:
a subcooler, comprising a cooling bath and connected between the tanker and the storage tank, is filled with the liquefied gas from the tanker up to a filling level and cooled to a bath temperature,
the storage tank is subsequently refilled with the liquefied gas from the tanker by the liquefied gas being pumped through a heat exchanger in the cooling bath of the subcooler into the storage tank by using a delivery pump, during which it is essentially cooled to the bath temperature of the cooling bath
wherein after the end of the filling process, the subcooler is no longer supplied with liquefied gas and therefore heats up.

The cryogenically liquefied gas is preferably cryogenically liquefied argon, cryogenically liquefied helium, cryogenically liquefied carbon dioxide or more particularly preferably cryogenically liquefied nitrogen (LIN). A stationary storage tank in the context of the present invention is intended to mean a large-volume tank which is suitable for holding a cryogenically liquefied gas and which, in particular, is installed in the vicinity of a consumer and can be refilled by means of a mobile tanker. A tanker in this context is intended to mean a vehicle which is suitable for transporting a cryogenically liquefied gas in a suitable container, in particular a holding tank.

A subcooler in the context of the present invention is intended to mean a cooling device which comprises a container holding a cooling bath, which can be filled with and hold a cryogenically liquefied gas. The cooling bath is arranged in the subcooler and insulated from the surroundings. A heat exchanger, which is in heat exchange with the cooling bath and through which a medium to be cooled can be fed, is furthermore formed in the subcooler. The delivery pump is arranged between the holding tank of the tanker and the subcooler, so that cryogenically liquefied gas can be supplied from the tanker. Preferably, the delivery pump is located on the tanker, but not necessarily kept cool all the time.

The cooling bath of the subcooler is first filled with the liquefied gas from the tanker. In this case, in particular, the cooling bath is filled with enough liquefied gas to reach a filling level above the heat exchanger arranged in the cooling bath. The tanker is connected to an inlet of the storage tank, so that the liquefied gas can be fed through a line system into the storage tank and/or into the cooling bath. Valves are arranged in the line system, by the actuation of which the liquefied gas can correspondingly be fed into the cooling bath and/or to the storage tank.

After a short equilibration time, the liquefied gas in the cooling bath assumes an essentially constant thermodynamic state. The temperature reached by the liquefied gas is referred to as the bath temperature and is essentially equal to or only insubstantially less than the temperature of the subcooled cryogenically liquefied gas in the tanker. In particular, a temperature of between −195° C. and −199° C. may be reached in this case.

After the liquefied gas in the cooling bath has reached the cooling bath temperature, liquefied gas is fed from the tanker through the heat exchanger in the subcooler to the inlet of the storage tank. In this case, the liquefied gas is supplied by a delivery pump, in particular a delivery pump which is not separately cooled and/or which is assigned to the tanker.

Although part of the energy introduced by the delivery pump is initially transferred to the liquefied gas as heat, the heat is nevertheless essentially transferred in the heat exchanger of the subcooler to the liquefied gas contained in the cooling bath, so that when it reaches the storage tank the cryogenically liquefied gas supplied from the tanker is raised only insubstantially above its starting temperature in the tanker. For most of the time during the delivery, the supplied cryogenically liquefied gas is in a liquid state and can be pumped against the pressure prevailing in the storage tank. The supplied cryogenically liquefied gas is also generally colder than the cryogenically liquefied gas held in the storage tank, and cools it further.

For this reason it is important to fill the storage tank through an inlet below a minimum filling level, preferably close to the bottom of the tank, to avoid that evaporated gas above the liquid gas in the tank is condensed, what would unnecessarily reduce the pressure in the stationary tank. On the other hand, a stationary tank usually acquires a certain vertical temperature profile between two filling processes and it can be advantageous to somewhat equalize this profile and to reduce the average temperature in the tank during the filling process, what can better be done through an inlet below the minimum filling level and by using a pump.

The advantage of this method is that the cryogenically liquefied gas can be supplied at a raised pressure by means of a pump, so that the time taken for the refilling process can be reduced by up to 70% compared with delivery without a pump. Furthermore, the pump used does not need to be in a low-temperature state at all times, since the heat generated by the pump is absorbed by the cooling bath of the subcooler. Compared with delivery without a pump, the method is furthermore energetically scarcely inferior since only the energy for cooling the subcooler or keeping it cold during the filling process additionally needs to be expended. The subcooler is generally cooled only for the duration of the refilling, and assumes the surrounding temperature between these times. It therefore does not need any additional attention or equipment for defrosting it, what makes it an uncomplicated component, which is located outside an thermal insulation of the stationary tank.

Preferably, the filling level and/or the pressure in the cooling bath of the subcooler are kept constant while the storage tank is being filled. To this end, in particular, cryogenically liquefied gas is branched off into the cooling bath during the filling process. For this purpose, in particular, valves in the line system, which are connected to a control unit, are switched accordingly. The control unit furthermore monitors the filling process by using level probes and temperature sensors. A venting valve is also arranged on the cooling bath, by means of which the pressure in the cooling bath can be reduced. In this way, constant conditions can be adjusted throughout the refilling process.

Particularly preferably, the pressure and/or the temperature in the tanker are kept constant while the storage tank is being filled. The conditions during the refilling process are also kept constant by this measure.

It is also preferred for the liquefied gas to be stored in the storage tank at a pressure of between 3 and 15 bar, preferably between 5 and 10 bar, and at a temperature lower than the liquefied gas's boiling temperature corresponding to the pressure. This means that the liquefied gas is in a subcooled state in the storage tank, in which case it may generally be assumed that the cryogenically liquefied gas in the tanker is at an even lower temperature. It also means, moreover, that the pressure in the storage tank is or remains elevated relative to the surrounding pressure during the refilling process. By means of this, initial venting of the storage tank can be obviated, so that more time is saved during the refilling process and consumers possibly connected to the storage tank are not exposed to pressure variations.

In particular, it is also an advantage that after the end of the filling process, the subcooler is no longer supplied with liquefied gas and therefore heats up. This means that the subcooler is kept at a low bath temperature only during the process of refilling with the liquefied gas. Between two refilling processes, the liquefied gas in the subcooler evaporates and the subcooler assumes the surrounding temperature. The subcooler therefore does not need to be continuously cooled, and it also cannot ice up. Cooling for the refilling process is achieved in just a short time by filling with the liquefied gas.

Another aspect of the invention provides a device for refilling a stationary storage tank from a tanker with a subcooled cryogenically liquefied gas from a tanker, in particular with liquid nitrogen, wherein an inlet of the storage tank is equipped with a subcooler, which comprises a cooling bath through which the liquefied gas can be fed from the tanker into the storage tank, wherein there is a delivery pump on the tanker or on the inlet side of the subcooler, by which the liquefied gas can be pumped under pressure through the cooling bath into the storage tank. The device is, in particular, configured and adapted for carrying out the method according to the invention.

Preferably, the subcooler is installed in the vicinity of the storage tank. The inlet should be close to the bottom of the tank and in any case below a minimum filling level of the liquefied gas in the tank. With the proposed device, the refilling of a storage tank can be carried out in a short time and can contribute to maintaining the liquefied gas in the tank under pressure and in a subcooled state.

According to an advantageous refinement of the device, means are provided for filling the subcooler with subcooled cryogenically liquefied gas from the tanker and/or for maintaining a predeterminable filling level of the cooling bath. These means preferably comprise a line system, valves, sensors and/or a control unit. In particular, a line system comprising valves is provided, which are arranged so that on the one hand the cooling bath can be filled with liquefied gas and/or the storage tank can be filled with liquid gas, the valves preferably being connected to the control unit. The control unit is furthermore connected to level probes and/or temperature sensors for monitoring the cooling bath and/or the storage tank, or the tanker. In this way, the refilling of the storage tank can be carried out almost automatically.

According to another advantageous refinement of the device, the storage tank is configured for a storage pressure of from 3 to 15 bar, preferably from 5 to 10 bar, and the delivery pump is configured for a corresponding pressure to fill against this pressure. This permits refilling with a corresponding liquefied gas under pressure, so that the filling time is greatly reduced.

The details and advantages disclosed for the method according to the invention can be adapted and applied to the device according to the invention and the tanker according to the invention, and vice versa.

The invention and the technical context will be explained by way of example below with the aid of the FIGURE. It should be pointed out that the FIGURE shows a particularly preferred embodiment of the invention, although the invention is not restricted to it.

The FIGURE schematically shows a device 8 for refilling a stationary storage tank 1 with a subcooled cryogenically liquefied gas. The device 8 comprises a tanker 2 which has a holding tank 16 in which the cryogenically liquefied subcooled gas is delivered. The device 8 furthermore comprises a subcooler 3 with a cooling bath 4, in which a heat exchanger 7 is formed. The subcooler 3 is connected via a line 9 and a delivery pump 6 to the holding tank 16 of the tanker 2, and it is furthermore connected via a line 9 to an inlet 19 of the storage tank 1. The inlet 19 is located below a minimum level 21 of liquefied gas in the tank 1, preferably close to the bottom 20 of the tank 1. The lines 9 and the subcooler 3 form a line network 17 via which, with the aid of the lines 9, cryogenically liquefied gas from the holding tank 16 of the tanker 2 can be fed through the heat exchanger 7 either into the cooling bath 4 or into the storage tank 1. To this end, two delivery valves 10 and one filling valve 13 are provided in the lines 9 and the line network 17. A level probe 14 and temperature sensors 15 are furthermore provided in the subcooler 3. The level probe 14, the temperature sensors 15, and the delivery valves 10 and the filling valve 13, are connected via signal lines 11 to a control unit 18 which monitors or regulates the refilling process. The subcooler 3 furthermore has a venting valve 12. Another venting valve 12 is also provided on the line 9.

In order to refill the storage tank 1, the holding tank 16 of the tanker 2 is connected to the subcooler 3 by means of the pump 6. First, the cooling bath 4 of the subcooler 3 is filled with cryogenically liquefied gas from the holding tank 16, up to a filling level 5 which lies above the heat exchanger 7. To this end, the supply valve 10 in the line 9 to the subcooler is opened and the supply valve 10 to the inlet 19 of the storage tank 1 is closed, the filling valve 13 being opened. After the cooling bath 4 has been filled with cryogenically liquefied gas, the cryogenically liquefied gas from the holding tank 16 of the tanker 2 is fed via the line 9 and the delivery pump 16 through the heat exchanger 7 to the inlet 19 of the storage tank 1. To this end, the supply valves 10 are opened and the filling valve 13 is closed.

If the cryogenically liquefied gas is nitrogen, for example, then there will be gaseous nitrogen GN and liquefied nitrogen LIN in the cooling bath 4. If, when refilling the storage tank, it is found by means of the level probe 14 or the temperature sensors 15 that the filling level 5 in the cooling bath 4 or the temperature in the cooling bath has become lower, then the cooling bath 4 may optionally be refilled with further cryogenically liquefied nitrogen via the filling valve 13. After the end of the filling process, the subcooler 3 needs not to be kept cool. It is therefore located outside a thermal insulation 22 of the tank 1 and allowed to warm up during the intervals between two filling processes.

The heat energy introduced by the delivery pump 6 into the low-temperature liquefied gas is transferred into the heat exchanger 7 to the low-temperature liquefied gas contained in the cooling bath 4. For this reason, the storage tank 1 can also be filled by means of a delivery pump 6, so that the time taken for the refilling process can be kept very short.

The teaching according to the invention permits rapid refilling of a stationary storage tank 1 by a tanker 2, so that an individual tanker 2 can fill a greater number of storage tanks per day. Tankers 1 and their crew can therefore be used much more effectively. Moreover, pressure variations in the storage tank during the filling process can be reduced.

### LIST OF REFERENCES

1 stationary storage tank
2 tanker
3 subcooler
4 cooling bath
5 filling level
6 delivery pump
7 heat exchanger
8 device
9 line
10 supply valve
11 signal line
12 venting valve
13 filling valve
14 level probe
15 temperature sensor
16 holding tank
17 line network
18 control unit
19 inlet
20 bottom
21 minimum level
22 thermal insulation
GN gaseous nitrogen
LIN liquefied nitrogen

1-11. (canceled)

12. A method for refilling a stationary storage tank with a cryogenically liquefied gas from a tanker, in particular with liquefied nitrogen, comprising the following steps:
a subcooler, comprising a cooling bath and connected between the tanker and the storage tank, is filled with the liquefied gas from the tanker up to a filling level and cooled to a bath temperature; and
the storage tank is subsequently refilled with the liquefied gas from the tanker by the liquefied gas being pumped through a heat exchanger in the cooling bath of the subcooler into the storage tank by using a delivery pump, during which it is essentially cooled to the bath temperature of the cooling bath, wherein after the end of the filling process, the subcooler is no longer supplied with liquefied gas and therefore heats up.

13. The method of claim 12, wherein the filling level and/or the pressure in the cooling bath of the subcooler are kept constant while the storage tank is being filled.

14. The method of claim 12, wherein the pressure and/or the temperature in the tanker are kept constant while the storage tank is being filled.

15. The method of claim 12, wherein the liquefied gas is stored in the storage tank at a pressure of between 3 and 15 bar and at a temperature lower than the liquefied gas's boiling temperature corresponding to the pressure.

16. The method of claim 12, wherein the liquefied gas is stored in the storage tank at a pressure of between 5 and 10 bar and at a temperature lower than the liquefied gas's boiling temperature corresponding to the pressure.

17. The method of claim 12, wherein the refilling of the storage tank is done through an inlet below a minimum level of the liquefied gas in the storage tank, in particular through an inlet close to the bottom of the storage tank.

18. The method of claim 17, wherein the inlet is close to the bottom of the storage tank.

19. The method of claim 12, wherein the liquefied gas is liquid nitrogen.

20. A device for refilling a stationary storage tank from a tanker with a subcooled liquefied gas, wherein an inlet of the storage tank is equipped with a subcooler, which comprises a cooling bath and means for filling the subcooler with subcooled liquefied gas from the tanker, through which cooling bath the liquefied gas can be fed from the tanker into the storage tank, wherein there is a delivery pump on the tanker or on the inlet side of the subcooler, by which the liquefied gas can be pumped under pressure through the cooling bath into the storage tank.

21. The device of claim 20, wherein means are provided for maintaining a predeterminable filling level of the cooling bath.

22. The device of claim 20, wherein the inlet of the storage tank is below a minimum level of the liquefied gas in the storage tank, in particular close to the bottom of the storage tank.

23. A stationary storage tank for liquefied gas, in particular liquid nitrogen comprising a subcooler connected to an inlet of the storage tank below a minimum level of the liquefied gas in the storage tank, especially close to the bottom of the storage tank.

24. The stationary storage tank of claim 23, wherein the subcooler is located externally of a thermal insulation of the storage tank such that its temperature is independent of that of the storage tank.
